(19) United States
(12) Patent Application Publication
(10) Pub. No.: US 2022/0010987 A1
(43) Pub. Date: Jan. 13, 2022

(54) AIR FILTRATION APPARATUS FOR REMOVING VIRUS PARTICLES

(71) Applicant: Philip Ugorowski, Oberlin, OH (US)

(72) Inventors: Philip Brien Ugorowski, Oberlin, OH (US); Heather Lane Ugorowski, Oberlin, OH (US); Mark Stillman Bradfield, Kalamazoo, MI (US)

(73) Assignee: Philip Ugorowski, Oberlin, OH (US)

(21) Appl. No.: 17/175,760

(22) Filed: Feb. 15, 2021

Related U.S. Application Data
(60) Provisional application No. 63/102,890, filed on Jul. 9, 2020.

(51) Int. Cl. F24F 3/163; B01D 46/00; B01D 46/10

(52) U.S. Cl. CPC F24F 3/163; B01D 46/0028; B01D 2279/65; B01D 2279/51; B01D 46/10

(57) ABSTRACT

An air filtration system is provided. The system includes one or more air delivery pipes disposed above, and in fluid communication with, an occupiable space. The delivery pipe supplies clean air to the space through a plurality of air apertures disposed along a length of the air delivery pipe. The apertures are configured to provide a flow of air out of the air delivery pipe that is constant along the length of the air delivery pipe. A similar one or more air exhaust pipes are disposed below, and in fluid communication with, the occupiable space.

This application incorporates by reference in its entirety U.S. Provisional Patent Application No. 63/102,890 filed Jul. 9, 2020 and now pending.

### I. BACKGROUND OF THE INVENTION

### A. Field of Invention

The invention relates to the field of air purification devices.

### B. Description of the Related Art

Typical indoor commercial spaces employ an air handling system that blows air into a room in a series of spaced air vents along a pipe or duct, and draws air out of the room in a likewise-spaced series of vents along a separate pipe or duct. Many commercial establishments with a large number of patrons in the same room (e.g. restaurants, taverns) also have ceiling fans causing turbulent airflows, mixing the air in the room. This arrangement made ‘No-Smoking’ areas particularly ineffective in the past. Further, systems that create turbulent flow necessarily allow particles to persist in the air for a longer period of time compared to laminar flow, because turbulence increases the pathlength of a particle traversing the air space.

It has long been a practice in hospital surgery rooms to have a horizontal laminar (single-direction) air flow, to prevent airborne particles from settling on the surface of the patient and the patient's exposed tissues. While sensible for an operating room, a horizontal flow is not necessarily best for a public gathering space like a bar or restaurant. Specifically, virus particles exhaled by one person would be blown in the face of a person standing downstream, defeating the purpose of any air cleaning elements that may be installed in the HVAC system.

Some embodiments of the present invention may provide one or more benefits or advantages over the prior art.

### II. SUMMARY OF THE INVENTION

Embodiments of the invention comprise air filtration systems suitable for use in indoor spaces, especially public indoor spaces. The invention can be installed in an occupiable space, but the invention encompasses systems prior to installation. Embodiments can include an air delivery pipe disposed above, and in fluid communication with, an occupiable space. The air delivery pipe has an open end extending to the first end of the occupiable space, and a closed end extending to the second end of the occupiable space. The air delivery pipe includes a plurality of air apertures disposed along its length and configured to provide a flow of air out of the air delivery pipe. The air flow is constant along the length of the air delivery pipe.

Embodiments also include an air exhaust pipe disposed below, and in fluid communication with, the occupiable space. The air exhaust pipe has an open end extending to the first end of the occupiable space, and a closed end extending to the second end of the occupiable space. The air exhaust pipe includes a plurality of air apertures disposed along its length and configured to provide a flow of air into the air exhaust pipe. The air flow is constant along the length of the air exhaust pipe. Embodiments further include an air driving element in fluid communication with the open end of the air exhaust pipe and the open end of the air delivery pipe. The air driving element is configured to provide a net flow of air from the air delivery pipe, across the occupiable space, and to the air exhaust pipe. Finally, embodiments include an air cleaning element in fluid communication with the open end of the air exhaust pipe and the open end of the air delivery pipe.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof, wherein like reference numerals indicate like structure, and wherein:

FIG. 1 is a drawing of a pipe illustrating an increasing density of air apertures from right to left;

FIG. 2 is a drawing of the air aperture of FIG. 1 indicated by reference numeral 2;

FIG. 3 is a partial view drawing of an embodiment installed and operating;

FIG. 4 is a cross sectional view of an air exhaust pipe installed in a floor;

FIG. 5 is a partial view of an embodiment showing an air driving element and a bag-type air cleaning element; and

FIG. 6 is a partial view of an embodiment showing an air driving element and a cartridge-type air cleaning element.

### IV. DETAILED DESCRIPTION OF THE INVENTION

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

Terms of degree, terms of approximation, and/or subjective terms may be used herein to describe certain features or elements of the invention. In each case sufficient disclosure is provided to inform the person having ordinary skill in the art in accordance with the written description requirement and the definiteness requirement of 35 U.S.C. 112.

The term efficiency is used herein to describe a performance characteristic of an embodiment. More specifically, one formulation of efficiency according to embodiments of the invention is a measure of the amount of a resource required to remove a unit of particulate contaminants from an air mass. The resource may be an amount air expressed in a convenient unit such as volume or mass, or the resource may be time, energy, or any other resource. Efficiency may be expressed in a variety of quantitative terms, but one meaningful and convenient mode of expressing efficiency is the time-rate of particle removal i.e., the number of particles removed per unit time, or the volume-rate of particle removal i.e., the volume of air that must be removed from a space to remove a unit of particulate contaminant. Alternatively, a measure of efficiency may be expressed as the average dwell time of a particulate contaminant in a volume of air compared to a standard. Further, efficiency can be formulated as a ratio of quantities expressed as a percentage. For example, a measured particle removal rate of a system under actual use conditions can be compared to the rate of the same system under ideal conditions.

Embodiments of the invention deliver a vertical, downwardly directed, laminar airflow to sweep particulates, especially viral particles, out of a space for human occupation, referred to herein as an occupiable space. Laminar flow decreases dwell time of particles as compared to turbulent flow, and the downward direction of flow allows embodiments to work with gravity, further decreasing dwell time and promoting laminar flow. For illustration only, nonlimiting examples of occupiable spaces include bars, restaurants, concert halls, banquet halls, convention centers, shopping centers, and other indoor places of public gathering.

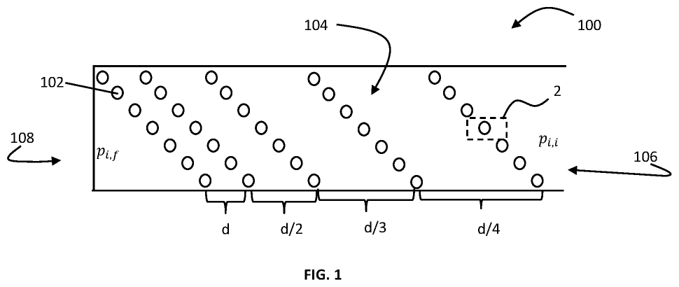

Turning now to the figures, the drawings provided herein are intended only to illustrate the principles and embodiments of the invention and are not to be interpreted as limiting the present invention. With reference to FIG. 1, embodiments include one or more air delivery pipes 100 or tubes having a plurality of air apertures 102 allowing for fluid communication between the inside of the air delivery pipe 100 and the outside of the air delivery pipe 100. The air delivery pipe 100 has an open end 106 for receiving air flow and a closed end 108. The open end 106 extends to a first end of the occupiable space (not shown) and the closed end 108 extends to a second end of the occupiable space (not shown). The internal air pressure of an air delivery pipe decreases along its length as air is expelled from the air apertures 102. As shown in FIG. 1, an initial internal pressure p_{i,i} where air enters the open end 106 of an air delivery pipe drops to a final internal p_{i,f} at the closed end 108 of the pipe 100. Assuming radius remains constant for all air apertures 102, in order to maintain a constant flow rate per unit length of the air delivery pipe 100 (i.e. a constant linear flow rate), the apertures 102 increase in density d at a constant rate from the high internal pressure p_{i,i} end to the low internal pressure p_{i,f} end of the pipe 100. For simplicity of illustration the linear density d of the apertures 102 is shown in FIG. 1 decreasing in integer divisors d, d/2, d/3, and d/4; however, this is merely for illustration and not intended to be a limitation of the invention.

The person having ordinary skill in the art will understand that air flow rate Q through an individual aperture 102 is governed by the Hagen-Poiseuille law (Eq. 1):

$$Q = \frac{Δ p π {R}^{4}}{8 μ L} \qquad ( Eq . 1 )$$

According to Eq. 1, flow rate Q from an individual aperture 102 is the product of the pressure difference Δp between the inside 200 and outside 202 of the pipe 100, the number π, and the radius R of the aperture 102 to the fourth power, divided by the product of eight times the dynamic viscosity μ of air and the thickness of the aperture L.

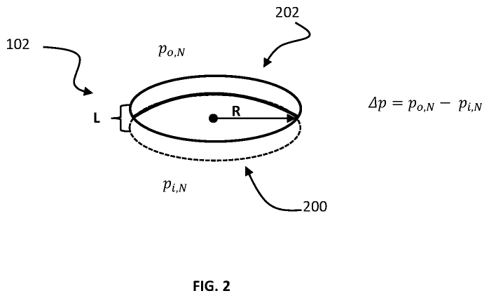

FIG. 2 is a close-up view of the aperture in dashed box 2 of FIG. 1 The variables R, and L are shown in FIG. 2 in relation to an aperture 102 according to an embodiment of the invention. Also shown in FIG. 2 are the pressures inside p_{i,N} and outside p_{o,N} of the pipe 100 through aperture 102. Here, the indices i and o mean inside and outside respectively, and the index N indicates an arbitrary point N along the length of the pipe 100.

A flow rate Ω of a delivery or exhaust pipe per unit length can be expressed as shown in Eq. 2 as the sum of the flow rates Qₙ over a length Δl of pipe 100. Flow rate Ω is also referred to herein as linear flow rate. Here the indices i and f mean initial and final respectively and n is an integer indicating individual apertures 1, 2, 3 . . . n.

Ω=Σₙ₌ᵢ^{n=f}Qₙ/Δl (Eq. 2)

The linear flow rate Ω of pipe 100 can be held constant over its length by varying the linear density d of apertures 102, and/or by varying the radius R of the apertures 102. Accordingly, a plurality of air apertures disposed along a length of an air delivery pipe can be configured to provide a flow of air out of the air delivery pipe that is constant along the length of the air delivery pipe by appropriately varying the linear density d of apertures 102, the radius R of the apertures, or both. It will be understood by the person having ordinary skill in the art that the word constant, in this context, is not to be interpreted in an absolute sense as perfectly constant. Nor is constant air delivery a requirement of the invention. Rather, constant air delivery is an ideal condition where embodiments operate at a global or local optimum; however, operational embodiments can include significant deviations from the ideal condition. For example, an operational embodiment can exhibit deviations of 10% or more in air flow rate through apertures at extreme opposing ends of an air delivery pipe.

More important than the percentage drop across an air delivery pipe is the rate at which pressure drops, the uniformity of the drop, and the minimum flow rate along the air delivery pipe. For example, if the flow rate changes abruptly over a short distance, turbulent flow could result which would degrade the embodiment's particulate removal efficiency. Similarly, if the flow rate drops too quickly along the length of an air delivery pipe the flow rate at the closed distal end of the pipe may be too low to sweep particulates from the air. While embodiments are intended to promote laminarity, and operate optimally with perfectly laminar flow, perfect laminarity is not a requirement of the invention.

Like constant airflow rate, laminarity is an ideal condition, but operational embodiments can deviate significantly from the ideal. The person having ordinary skill in the art will understand that placing objects in an otherwise laminar airflow can cause turbulent flow. Thus, even an ideal embodiment can still have local areas of turbulent flow because turbulence can be caused by factors external to the embodiment e.g., furniture in the airflow path, or persons and objects moving through an occupiable space. Even with areas of local turbulence, embodiments of the present invention are not only operational, they are significant improvements over the prior art.

Embodiments can include a plurality of parallel air delivery pipes disposed above, and in fluid communication with, an occupiable space that deliver air evenly to the entire space. For example, and without limitation, in one embodiment air could be supplied to a 10′×10′ space using six-inch diameter pipes running from a first end to a second end of the occupiable space in parallel and radially spaced apart such that they deliver suitably constant airflow to the entire 10′×10′ space.

The air exhaust pipes according to embodiments of the invention operate according to the same constant flow principles as the air delivery pipes and therefore can be constructed identically to the air delivery pipes. Although identical construction is not a requirement of the invention, the upshot is that all the foregoing structural and theoretical description pertaining to the air delivery pipes, also applies to the air exhaust pipes. Accordingly, no further description of the construction and operation of individual air exhaust pipes is necessary.

A plurality of air exhaust pipes disposed below, and in fluid communication with, the occupiable space provides a flow path for air to exit the occupiable space as cleaned air enters through the air delivery pipes. The air exhaust pipes have an open end extending to the first end of the occupiable space and a closed end extending to the second end of the occupiable space. Like the air delivery pipes, the exhaust pipes have air apertures increasing in density or radius from the open end to the closed end of the air exhaust pipe. Also like the air delivery pipes, the air exhaust pipes run in parallel to allow for an even exhaust rate over the entire occupiable space.

Embodiments enclose the air delivery pipes e.g., in a ceiling or drop ceiling, and are separated from the occupiable space by ceiling tiles that collimate or laminarize the air flow to the occupiable space using baffles. Similarly constructed floor tiles comprising baffles may be used to maintain laminar flow as air exhausts from the occupiable space.

Embodiments include an air driving element to impel air flow from the air delivery pipes, downwardly across the occupiable space, to the air exhaust pipes. The air driving element may be integrated into an embodiment such that it receives airflow from the open end of the exhaust pipes and impels it toward the open end of the air delivery pipes. Air driving elements according to the invention can comprise a fan, a bellows, a pump, or any other element known in the art to be suitable for forcing ventilation air.

Embodiments also include an air cleaning element receiving contaminated air from the open end of the air exhaust pipe and conveying clean air to the open end of the air delivery pipe. The air cleaning element may be in-line with i.e., upstream or downstream of, the air driving element as a matter of design choice. Air cleaning elements according to the invention can comprise filters, like HEPA filters, corona discharge units, or any other element known in the art to be suitable for removing particulate contaminants from ventilation air.

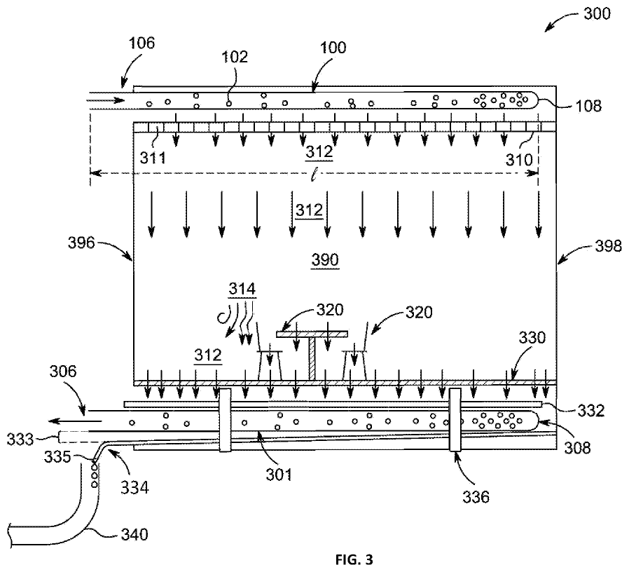

FIG. 3 illustrates how an embodiment 300 can be constructed by retrofitting elements to an existing structure. An air delivery pipe 100 is shown with an open end 106 extending to and even beyond the first end 396 of the occupiable space 390, and closed end 108 extending roughly to a second end 398 of the occupiable space 390. The air apertures 102 of the air delivery pipe are shown increasing in density along the length e of the pipe 100. The variable density of apertures allows for maintaining a constant flow rate as indicated by the constant spacing of lines 312. The airflow passes through ceiling 310 having laminarizing baffles 311 that produce laminarized air flow as indicated by the fact that lines 312 are straight and parallel to each other. Wavey lines 314 illustrate a deviation from laminar flow as the airflow bends around furniture 320 obstructing the flow path. While not ideal, deviations like these are expected in operation and still result in operational embodiments.

With continuing reference to FIG. 3, an air exhaust pipe 301 is shown with an open end 306 extending to and somewhat beyond the first end 396 of the occupiable space 390, and a closed end 308 extending roughly to the second end 398 of the occupiable space 390. The airflow 312 is shown communicating through the baffled floor 330 to the exhaust pipe 301. Similar to the air delivery pipe 100, in the air exhaust pipe 301 the density of air apertures 102 increase from the open end 306 to the closed end 308. Thus, less pressure is required to compel the air flow into the closed end 308 compared to the open end 306 while maintaining a constant airflow rate across the length of the pipe 301.

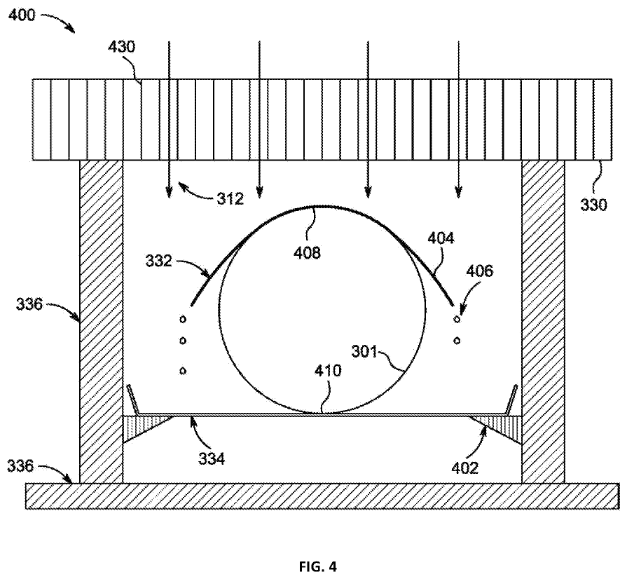

Beneath the floor 330, a splash guard 332 is disposed along a topside length of the air exhaust pipe 301. Though not visible in this view, the lateral edges of the splash guard 332 extend across an entire diameter of the air exhaust pipe 301, thereby protecting it from wash water used to clean the floor 330 (See FIG. 4). Water falling through the floor 330 baffles falls onto the splash guard 332 and flows off the edges thereof. The water is caught by a drip pan 334 which slopes 333 downwardly toward a drain 340. The drip pan 334 illustrated in FIG. 3 includes an optional lip 335 to assist in directing water to the drain 340. The drip pan 334 is attached to floor braces 336 which fixes its downward slope.

Turning to FIG. 4, a cross sectional view 400 is shown of an air exhaust pipe 301 installed under a floor 330 comprising laminarizing baffles 430. A laminar air flow is indicated by straight lines 312 passing between baffles 430 at a constant flow rate indicated by the even spacing of the lines 312. The splash guard 332 is shown disposed along a topside length 408 with lateral edges 404 extending across the entire diameter of the exhaust pipe 301. Water 406 is shown draining from the lateral edges 404 of the splash guard 332 and into the drip pan 334 disposed along an underside length 410 of the pipe 301 and extending laterally beyond the lateral edges 404 of the splash guard 332. The drip pan 334 is supported by brackets 402 attached to the floor braces 336.

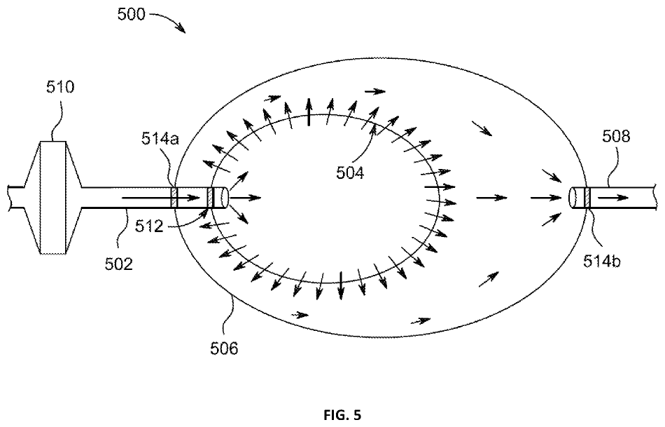

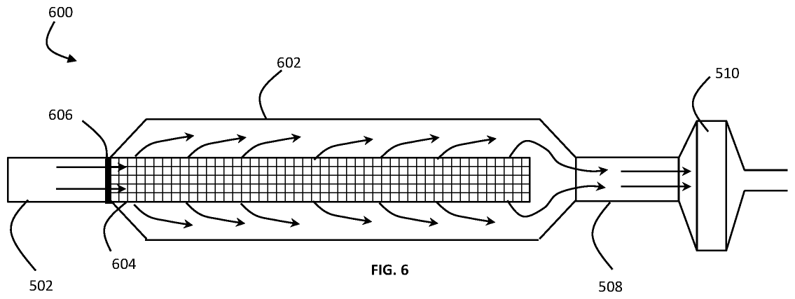

FIGS. 5 and 6 illustrate air cleaning elements of an embodiment. In FIG. 5 a bag-type air cleaning element 500 is shown. It includes an intake pipe 502 delivering dirty air from the air exhaust pipe 301 (see FIG. 3). The intake pipe 502 could be an extension of the air exhaust pipe 301, or it may communicate with the air exhaust pipe 301 through a plenum (not shown) through which the intake pipe receives air flow from a plurality of exhaust pipes 301. An outer bag 506 is shown joined 514a to the intake pipe 502 at one end and joined 514b to an output pipe 508 at an opposing end. An inner bag 504 made of filter material is also shown joined 512 to the intake pipe 502. Dirty air flows into the inner bag 504 which passes clean filtered air as indicated by the airflow arrows. The outer bag 506 is impermeable and therefore forces the airflow into output pipe 508. The air flow is due to the air driving element 510 which may be a fan or other air impelling device known in the art, such as a bellow or other air pump. The air driving element 510 is shown in FIG. 5 on the intake side of the air cleaning element 500 and FIG. 6 shows the air driving element 510 on the output side of the air cleaning element 500. This is intended to illustrate the fact that embodiments can operably place the air driving element 510 in either position.

FIG. 6 shows an air cleaning element 600 having an air filter cartridge 604 rather than a bag. The air intake pipe 502 is joined 606 to filter cartridge 604 which is enclosed by impermeable outer pipe 602. Air is drawn from intake pipe 502 by air driving element 510, and into filter cartridge 604 which passes clean air to the air output pipe 508.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I claim:

1. An air filtration system comprising:
an air delivery pipe disposed above, and in fluid communication with, an occupiable space having a first end and a second end, the air delivery pipe having an open end extending to the first end of the occupiable space, and a closed end extending to the second end of the occupiable space;
a plurality of air apertures disposed along a length of the air delivery pipe are configured to provide a flow of air out of the air delivery pipe that is constant along the length of the air delivery pipe;
an air exhaust pipe disposed below, and in fluid communication with, the occupiable space, the air exhaust pipe having an open end extending to the first end of the occupiable space, and a closed end extending to the second end of the occupiable space;
a plurality of air apertures disposed along a length of the air exhaust pipe are configured to provide a flow of air into the air exhaust pipe that is constant along the length of the air exhaust pipe;
an air driving element in fluid communication with the open end of the air exhaust pipe and the open end of the air delivery pipe, the air driving element being configured to provide a net flow of air from the air delivery pipe, across the occupiable space, and to the air exhaust pipe; and
an air cleaning element in fluid communication with the open end of the air exhaust pipe and the open end of the air delivery pipe.

2. The air filtration system of claim 1, where the air delivery pipe is one of a plurality of air delivery pipes arranged in parallel to each other, wherein each air delivery pipe has an open end extending to the first end of the occupiable space, and a closed end extending to the second end of the occupiable space.

3. The air filtration system of claim 1, wherein the air apertures are disposed along a length of the air delivery pipe according to an increasing density from the open end of the air delivery pipe to the closed end of the air delivery pipe.

4. The air filtration system of claim 3, wherein the density of the air aperture of the air delivery pipe varies at a constant increasing rate from the open end of the air delivery pipe to the closed end of the air delivery pipe.

5. The air filtration system of claim 1, where the air exhaust pipe is one of a plurality of air exhaust pipes arranged in parallel to each other, wherein each air exhaust pipe has an open end extending to the first end of the occupiable space, and a closed end extending to the second end of the occupiable space.

6. The air filtration system of claim 1, wherein the air apertures are disposed along a length of the air exhaust pipe according to an increasing density from the open end of the air exhaust pipe to the closed end of the air exhaust pipe.

7. The air filtration system of claim 6, wherein the density of the air aperture of the air exhaust pipe varies at a constant increasing rate from the open end of the air exhaust pipe to the closed end of the air exhaust pipe.

8. The air filtration system of claim 1, wherein the air driving element is selected from one or more of a fan, a bellows, or a pump.

9. The air filtration system of claim 1, wherein the air cleaning element is in-line with the air driving element.

10. The air filtration system of claim 9, wherein the air cleaning element is upstream of the air driving element.

11. The air filtration system of claim 1, further comprising a ceiling interposed between the air delivery pipe and the occupiable space, wherein the ceiling comprises a plurality of laminarizing baffles.

12. The air filtration system of claim 1, further comprising a floor interposed between the air exhaust pipe and the occupiable space, wherein the floor comprises a plurality of laminarizing baffles.

13. The air filtration system of claim 1, further comprising a splash guard disposed along a topside length of the air exhaust pipe, wherein lateral edges of the splash guard extend across an entire diameter of the air exhaust pipe.

14. The air filtration system of claim 13, further comprising a drip pan disposed along an underside length of the air exhaust pipe and extending laterally beyond the lateral edges of the splash guard.

15. The air filtration system of claim 14, wherein the drip pan slopes downwardly toward a drain.

16. An air filtration system installable to an occupiable space, the air filtration system comprising:
an air delivery pipe configured to be installed above, and in fluid communication with, an occupiable space having a first end and a second end, the air delivery pipe having an open end extendable to the first end of the occupiable space, and a closed end extendable to the second end of the occupiable space;
a plurality of air apertures disposed along a length of the air delivery pipe are configured to provide a flow of air out of the air delivery pipe that is constant along the length of the air delivery pipe;
an air exhaust pipe configured to be installed below, and in fluid communication with, the occupiable space, the air exhaust pipe having an open end extendable to the first end of the occupiable space, and a closed end extendable to the second end of the occupiable space;
a plurality of air apertures disposed along a length of the air exhaust pipe are configured to provide a flow of air into the air exhaust pipe that is constant along the length of the air exhaust pipe;
an air driving element configured to be installed in fluid communication with the open end of the air exhaust pipe and the open end of the air delivery pipe, the air driving element being configured to provide a net flow of air from the air delivery pipe, across the occupiable space, and to the air exhaust pipe; and
an air cleaning element configured to be installed in fluid communication with the open end of the air exhaust pipe and the open end of the air delivery pipe.

17. The air filtration system of claim 16, further comprising a ceiling interposable between the air delivery pipe and the occupiable space, wherein the ceiling comprises a plurality of laminarizing baffles.

18. The air filtration system of claim 16, further comprising a floor interposable between the air exhaust pipe and the occupiable space, wherein the floor comprises a plurality of laminarizing baffles.

19. The air filtration system of claim 16, further comprising a splash guard installable along a topside length of the air exhaust pipe, wherein lateral edges of the splash guard extend across an entire diameter of the air exhaust pipe when the splash guard is installed.

20. The air filtration system of claim 19, further comprising a drip pan disposed along an underside length of the air exhaust pipe and extend laterally beyond the lateral edges of the splash guard.
